(19) United States
(12) Patent Application Publication
(10) Pub. No.: US 2026/0211186 A1
(43) Pub. Date: Jul. 23, 2026

(54) DIELECTRIC WAVEGUIDE-BASED MULTI-MODE INTERFERENCE COUPLER AND INTERFEROMETER

(71) Applicant: SILITH TECHNOLOGY PTE. LTD., SINGAPORE (SG)

(72) Inventors: Xingyu ZHANG, Shanghai (CN); Ke ZHANG, Shanghai (CN)

(73) Assignee: SILITH TECHNOLOGY PTE. LTD., SINGAPORE (SG)

(21) Appl. No.: 19/565,484

(22) Filed: Mar. 12, 2026

Related U.S. Application Data
(63) Continuation of application No. PCT/CN2023/119107, filed on Sep. 15, 2023.

(51) Int. Cl. G02B 6/293; G02F 1/21; G02F 1/225

(52) U.S. Cl. CPC G02B 6/29344; G02F 1/211; G02F 1/212; G02F 1/217; G02F 1/225; G02F 2201/05

(57) ABSTRACT

Provides dielectric waveguide-based MMI coupler and interferometer, by arranging multi-mode waveguide and light absorber, one end of multi-mode waveguide connects to M input channels and another end connects to N output channels, wherein M and N are positive integers; light absorber comprises waveguide cladding, and optical waveguide core and absorbing material layer surrounded by waveguide cladding; wherein, optical waveguide core and absorbing material layer are not directly connected, optical waveguide core comprises first end and second end, radial dimension of optical waveguide core decreases gradually from first end to second end; first end connects to end of multi-mode waveguide where light absorber locates, materials of multi-mode waveguide and optical waveguide core are dielectrics and light absorber located at end of multi-mode waveguide can reduce return loss and eliminate reflected light, leading reflected light to be absorbed by absorbing material layer, thereby reducing reflection.

### CROSS-REFERENCE TO RELATED APPLICATION

This is a continuation of and claims the priority benefit of International Application No. PCT/CN2023/119107, filed on September 15, 2023. The entirety of the above-mentioned patent application is hereby incorporated by reference herein and made a part of this specification.

### FIELD OF THE APPLICATION

The present application relates to the technical field of optical components, and in particular to a dielectric waveguide-based multi-mode interference coupler and an interferometer.

### BACKGROUND

A multi-mode interference coupler (an MMI coupler) is a multi-mode interference structure based on an optical waveguide platform, which is widely applied in a plurality of applications in a photonic chip including light beam splitting, light beam combining, optical hybrid, and more. A number of optical input ports and a number of optical output ports may be M and N, wherein both M and N are no less than 1. Shown as FIG. 1, since a multi-mode interference area of the MMI coupler is rectangle-shaped, there are a plurality of abrupt changes on width of a waveguide in the multi-mode interference area and between an input waveguide and an output waveguide, and there is usually a right angle at each of four corners, thus there will always generate a certain reflection, that is, a return loss. A plurality of optical waveguide structures, devices and photonic chips may be developed based on the MMI coupler, including a Mach-Zehnder interferometer (MZI) modulator, a Sagnac interferometer, an interferometric optical gyroscope, an optical switch or a semiconductor ring laser. In a plurality of applications, a photonic chip and a system are both sensitive to an optical reflection. Thus it is necessary to find a method to reduce a reflection in the MMI coupler.

On a dielectric optical waveguide (such as a silicon dioxide waveguide, a polymer waveguide, a silicon nitride waveguide, an aluminum nitride waveguide, and more), a reflected light or a stray light cannot be absorbed by means of forming an absorber through an ion doping as done on a semiconductor optical waveguide (such as silicon and more). Therefore, for a dielectric waveguide-based MMI coupler, in the prior art, a simple approach is transmitting light from a dielectric optical waveguide to a semiconductor material, such as silicon, by a transition structure, and then using an ion-doped semiconductor waveguide as an absorber. However, that will introduce an additional transition structure, making a structure of a component complicated. Another approach in the prior art is using an absorbing material, such as germanium (Ge). Germanium-on-silicon (Ge-on-Si) has been widely applied in an integrated optical component, acting as a photodetector. However, an epitaxial growth of the Ge may affect a yield of the integrated optical component, further affect a cost thereof; in addition, a surface of the dielectric optical waveguide and the Ge absorber may introduce some additional reflections.

Therefore, a novel dielectric waveguide-based MMI coupler and an interferometer are desired urgently to improve the problem mentioned above.

### BRIEF SUMMARY OF THE APPLICATION

An objective of the present application is providing a dielectric waveguide-based MMI coupler and an interferometer to overcome a plurality of reflection issues in an existing MMI coupler and an interferometer, reducing a return loss and eliminating reflected light.

In a first aspect, the present application provides a dielectric waveguide-based MMI coupler, comprising: a multi-mode waveguide, one end of the multi-mode waveguide is connected to M input channels and another end is connected to N output channels, wherein both M and N are positive integers; a light absorber, the light absorber comprises a waveguide cladding, an optical waveguide core and an absorbing material layer being surrounded by the waveguide cladding; wherein, the optical waveguide core and the absorbing material layer are not directly connected with each other; the optical waveguide core comprises a first end and a second end, while a radial dimension of the optical waveguide core decreases gradually from the first end to the second end; at least one end of the multi-mode waveguide has the light absorber arranged, and the first end of the optical waveguide core of the light absorber is connected to the end of the multi-mode waveguide where the light absorber is located; a material of both the multi-mode waveguide and the optical waveguide core of the light absorber is a dielectric.

The MMI coupler disclosed by the present application has an advantage that: by arranging the multi-mode waveguide and the light absorber, one end of the multi-mode waveguide is connected to M input channels and another end is connected to N output channels, wherein both M and N are positive integers; the light absorber comprises a waveguide cladding, an optical waveguide core and an absorbing material layer surrounded by the waveguide cladding; wherein, the optical waveguide core and the absorbing material layer are not directly connected with each other; the optical waveguide core comprises a first end and a second end, while a radial dimension of the optical waveguide core decreases gradually from the first end to the second end; at least one end of the multi-mode waveguide has the light absorber arranged, and the first end of the optical waveguide core of the light absorber is connected to the end of the multi-mode waveguide where the light absorber is locating; a material of both the multi-mode waveguide and the optical waveguide core of the light absorber is a dielectric. The light absorber arranged at the end of the multi-mode waveguide can reduce the return loss and eliminate the reflected light, making the reflected light be absorbed by the absorbing material layer, thereby reducing a reflection of the MMI coupler and/or the interferometer.

Optionally, an orientation of the light absorber is adjusted to be in any direction. An advantage thereof is that, by arranging the orientation of the light absorber to a proper angle, the absorber can be arranged following a desired direction, thereby improving an efficiency of absorbing the reflected light and reducing the return loss.

Preferably, the orientations of the light absorbers at different right angles in the multi-mode waveguide are same or different. An advantage is, by arranging the orientations of the light absorbers at different right angles in the multi-mode waveguide same or different, it is able to adjust the orientation of the light absorbers based on a characteristic of the input channel and the output channel and an actual situation at a different right corner, thereby reducing a reflection of the MMI coupler effectively.

Preferably, at least one of two adjacent right angles on the end where the input channel or the output channel of the multi-mode waveguide is located, has a light absorber arranged, and an orientation of each light absorber is in a direction parallel to or at an angle with an optical propagation direction of the multi-mode waveguide. An advantage is, when at least one of the two adjacent right angles on the end where the input channel or the output channel of the multi-mode waveguide is located has the light absorber arranged, and the orientation of each light absorber is in a direction parallel to or at an angle with the optical propagation direction of the multi-mode waveguide, an absorption efficiency of the light absorber to the reflected light existing in the input channel will be improved effectively.

Preferably, each of four right angles on the end of the multi-mode waveguide has a light absorber arranged, and the orientation of each light absorber is parallel to or at an angle with the optical propagation direction of the multi-mode waveguide. An advantage is, by arranging a light absorber at each of the four right angles of the end of the multi-mode waveguide, and the orientation of each light absorber is in a direction parallel to or at an angle with the optical propagation direction of the multi-mode waveguide, it is possible to absorb a reflected light generated at each of the four right angles of the multi-mode waveguide, thereby reducing a reflection of the MMI coupler.

Preferably, each of four right angles on the end of the multi-mode waveguide has one of the light absorbers arranged, and the first end of the optical waveguide core in each of the light absorbers is connected with the right angle of the multi-mode waveguide where the light absorber is located. An advantage is, by arranging the first end of the light absorber locating at each of the four right angles on the end of the multi-mode waveguide to connect directly with the right angle of the multi-mode waveguide where the light absorber is located, it is able to improve an absorption efficiency of the reflected light.

Preferably, further comprising: a polarization rotator, through the polarization rotator, the first end of the optical waveguide core in the light absorber is connected with the right angle of the multi-mode waveguide where the light absorber is located. An advantage is, by arranging the polarization rotator, a TE (transverse electric) polarized light being input is rotated for 90 degrees and converted into a TM (transverse magnetic) polarized light, and the TM polarized light is then output to the light absorber, since the light absorber has a higher absorption efficiency to the TM polarized light, such a structure is able to absorb a light wave more efficiently.

Preferably, a shape of the optical waveguide core is tapered or wedge-shaped, and the optical waveguide core is arranged in a straight line, or in a spiral shape or a folded loop in a two-dimensional (2D) space or a three-dimensional (3D) space. An advantage is, by arranging the shape of the optical waveguide core tapered or wedge-shaped, since a tapered or wedge-shaped dielectric optical waveguide makes a size of an optical mode increase gradually, when a profile of an optical mode is expanded larger and larger, a tail of the optical mode (a non-physical structure, referring to an edge of an optical mode field formed by a light spot spreading outward after becoming bigger) starts to touch the absorbing material layer on an upside, due to the absorbing material layer introducing absorption, thus an optical power propagating along the waveguide is attenuated, while an adiabatic transition is smooth enough, an abrupt change is avoided, thus a backward-reflection can be reduced significantly. By arranging the optical waveguide core in the straight line, or in the spiral shape or the folded loop in the 2D space or the 3D space (e.g. spiral/folded up or down), it helps to save a space in a photonic integrated circuit component, thus an integration level of the photonic integrated circuit component is higher.

Preferably, the absorbing material layer is located on an upper layer of the optical waveguide core, or on a side of the optical waveguide core, or on an oblique side of the optical waveguide core, or on a lower layer of the optical waveguide core. An advantage is, by arranging the absorbing material layer on the upper layer, the side, the oblique side or the lower layer of the optical waveguide core, it is possible to adjust a shape of the light absorber according to an actual requirement, enabling the light absorber to be applicable to a plurality of different application scenarios.

In a second aspect, the present application further provides an interferometer, the interferometer comprises at least one MMI coupler according to any one of the MMI coupler described in the first aspect and a waveguide routing or a coil connected with the input channel or the output channel of the MMI coupler.

Preferably, the interferometer is a Mach-Zehnder interferometer modulator, a Sagnac interferometer, an interference type optical gyroscope, an optical switch or a semiconductor ring laser.

An advantage of the second aspect can refer to the specific description stated in the first aspect.

Preferably, when the interferometer is the Sagnac interferometer, at least one of two adjacent right angles on the end where the input channel of the multi-mode waveguide in the MMI coupler is located has a light absorber arranged, and an orientation of each light absorber is parallel to or at an angle with the optical propagation direction of the multi-mode waveguide; one output channel of the multi-mode waveguide is connected to one end of the coil, another output channel is connected to another end of the coil. An advantage is, by arranging a light absorber on at least one of the two adjacent right angles on the end where the input channel of the multi-mode waveguide in the Sagnac interferometer is located, and an orientation of each light absorber is in a direction parallel to or at an angle with the optical propagation direction of the multi-mode waveguide, the Sagnac interferometer is able to reflect a light completely, thereby minimizing a loss during a reflection process.

Preferably, the interferometer is the interferometric optical gyroscope, at least one of four right angles on the end of the multi-mode waveguide in the MMI coupler has a light absorber arranged, and an orientation of each light absorber is parallel to or at an angle with the optical propagation direction of the multi-mode waveguide; wherein, the coil is a spiral coil; one output channel of the multi-mode waveguide is connected to one end of the spiral coil, another output channel is connected to another end of the spiral coil; wherein, a winding of the spiral coil is located in a same plane or in different planes in a 3D space; when the spiral coil is located in the same plane, a waveguide crossing is comprised. An advantage is, by arranging a light absorber on at least one of the four right angles on the end of the multi-mode waveguide in the interferometric optical gyroscope, and the orientation of each light absorber is in a direction parallel to or at an angle with the optical propagation direction of the multi-mode waveguide, it is possible to improve a reflection of the interferometric optical gyroscope; by arranging the coil a spiral coil, and the winding of the spiral coil in the same plane or in different planes in the 3D space, and when the spiral coil is located in the same plane, a waveguide crossing is comprised, it is possible to adjust a shape of the spiral coil according to an actual requirement, thus improving an integration level of the integrated circuit components.

Preferably, the spiral coil is integrated in a same chip or different chips, or is an optical fiber spiral coil coupled externally. An advantage is, by integrating the spiral coil in the same chip or different chips, or be an optical fiber spiral coil coupled externally, the interferometric optical gyroscope is able to be applied to different application scenarios.

Preferably, the interferometer is a Mach-Zehnder interferometer, the Mach-Zehnder interferometer comprises a first MMI coupler, a second MMI coupler, a first waveguide routing and a second waveguide routing;

at least one of two adjacent right angles on the end where the input channel of the first multi-mode waveguide in the first MMI coupler is located has a light absorber arranged, and each light absorber is arranged in a direction parallel to or at an angle with the optical propagation direction of the first multi-mode waveguide;

at least one of two adjacent right angles on the end where the output channel of the second multi-mode waveguide in the second MMI coupler is located has a light absorber arranged, and each light absorber is arranged in a direction parallel to or at an angle with the optical propagation direction of the second multi-mode waveguide;

an output channel of the first multi-mode waveguide is connected to an input channel of the second multi-mode waveguide through the first waveguide routing;

another output channel of the first multi-mode waveguide is connected to another input channel of the second multi-mode waveguide through the second waveguide routing; wherein a length of the first waveguide routing and a length of the second waveguide routing may be same or different. An advantage is, by arranging the Mach-Zehnder interferometer comprising the first MMI coupler, the second MMI coupler, the first waveguide routing and the second waveguide routing, and arranging four light absorbers on two right angles on the end where the input channel of the first MMI coupler is located and on two right angles on the end where the output channel of the second MMI coupler is located, it is possible to reduce the return loss and eliminate the reflected light, making the reflected light to be absorbed by the absorbing material layer, thereby reducing a reflection of the Mach-Zehnder interferometer.

### BRIEF DESCRIPTION OF THE DRAWINGS

FIG. 1 illustrates a schematic structural diagram on a 1×2 MMI coupler in the prior art;

FIG. 2 illustrates a schematic structural diagram on a 1×2 MMI coupler provided by an embodiment of the present application;

FIG. 3 illustrates a side view on a 1×2 MMI coupler provided by an embodiment of the present application;

FIG. 4 illustrates an overall schematic structural diagram on a light absorber provided by an embodiment of the present application;

FIG. 5 illustrates another overall schematic structural diagram on a light absorber provided by an embodiment of the present application;

FIG. 6 illustrates a schematic structural diagram on an M×N MMI coupler provided by an embodiment of the present application;

FIG. 7 illustrates a schematic structural diagram on a 1×2 MMI coupler provided by an embodiment of the present application;

FIG. 8 illustrates a schematic structural diagram on a 1×1 MMI coupler provided by an embodiment of the present application;

FIG. 9 illustrates a schematic structural diagram on a 1×2 MMI coupler with a polarization rotator provided by an embodiment of the present application;

FIG. 10 illustrates a schematic structural diagram on a 2×1 MMI coupler provided by an embodiment of the present application;

FIG. 11 illustrates a transmission spectrum and a reflection spectrum of a conventional 2×1 MMI coupler without a light absorber;

FIG. 12 illustrates a transmission spectrum and a reflection spectrum of a conventional 2×1 MMI coupler with a light absorber;

FIG. 13 illustrates a light intensity distribution diagram on a conventional 2×1 MMI coupler without a light absorber;

FIG. 14 illustrates a light intensity distribution diagram on a conventional 2×1 MMI coupler with a light absorber;

FIG. 15 illustrates a schematic structure diagram on a Sagnac interferometer provided by an embodiment of the present application;

FIG. 16 illustrates a reflection spectrum on a Sagnac interferometer of a dielectric waveguide-based MMI coupler without a light absorber;

FIG. 17 illustrates a reflection spectrum on a Sagnac interferometer of a dielectric waveguide-based MMI coupler with a light absorber;

FIG. 18 illustrates a light intensity distribution diagram on a Sagnac interferometer of a dielectric waveguide-based MMI coupler without a light absorber;

FIG. 19 illustrates a light intensity distribution diagram on a Sagnac interferometer of a dielectric waveguide-based MMI coupler with a light absorber;

FIG. 20 illustrates a schematic structural diagram on an interference type optical gyroscope provided by an embodiment of the present application;

FIG. 21 illustrates a schematic structural diagram on a Mach-Zehnder interferometer provided by an embodiment of the present application;

wherein: 1. multi-mode waveguide; 2. input channel; 3. output channel; 4. light absorber; 5. polarization rotator; 6. coil; 7. first MMI coupler; 8. second MMI coupler; 9. first waveguide routing; 10. second waveguide routing; 41. waveguide cladding; 42. optical waveguide core; 43. absorbing material layer.

### DETAILED DESCRIPTION OF EMBODIMENTS

In order to make the objectives, technical solutions and advantages of the present application clearer, the technical solutions in the embodiments of the present application will be clearly and completely described below with reference to the accompanying drawings. Obviously, the embodiments mentioned are part of the embodiments of the present application, instead of all of the embodiments. According to the embodiments of the present application, all other embodiments achieved by a skilled in the art without devoting any creative effort are all within the scope of protection of the present application. Unless otherwise defined, technical or scientific terms used herein shall have the meanings commonly understood by those of ordinary skills in the art to which the present application belongs. The term "comprise" and other similar terms used herein are intended to indicate that the component or item appearing before the term comprises the component or item appearing after the word and the equivalents thereof, without excluding other components or items.

Taking a spiral-shaped coupler as an example, as shown in FIG. 2 and FIG. 3, the present application provides a dielectric waveguide-based MMI coupler, adding a light absorber 4 to a multi-mode waveguide 1 of the dielectric waveguide-based MMI coupler, and eliminating an unwanted reflected light by the light absorber 4. Wherein, FIG. 2 illustrates a top view and FIG. 3 illustrates a side view. By arranging the light absorber 4 at a corner of the multi-mode waveguide 1 in the MMI coupler which cannot avoid intrinsic reflection, any reflected light is absorbed, that is, making a reflection of the light impossible, thereby reducing a return loss and eliminating the reflected light. The light absorber 4, the light absorber 4 comprises a waveguide cladding 41 (not shown in the figure), and an optical waveguide core 42 and an absorbing material layer 43 surrounded by the waveguide cladding 41; wherein, the optical waveguide core 42 and the absorbing material layer 43 are not directly connected; the optical waveguide core 42 comprises a first end and a second end, while a radial dimension of the optical waveguide core 42 decreases gradually from the first end to the second end; at least one end of the multi-mode waveguide 1 has the light absorber 4 arranged, and the first end of the optical waveguide core 42 of the light absorber 4 is connected to the end of the multi-mode waveguide 1 where the light absorber 4 is located; a material of both the multi-mode waveguide 1 and the optical waveguide core 42 of the light absorber 4 is a dielectric. Wherein, the light absorber 4 is connected with the corner through a connecting waveguide, the connecting waveguide can be routed following a desired direction, while a size of the connecting waveguide, a distance to the end, and more, are not limited herein. It should be noted that, the optical waveguide core 42 arranged in a spiral shape as shown in FIG. 2 can also be arranged in a straight line or a folded loop, or even be arranged in a spiral shape or in a folded loop in a 2D space or a 3D space.

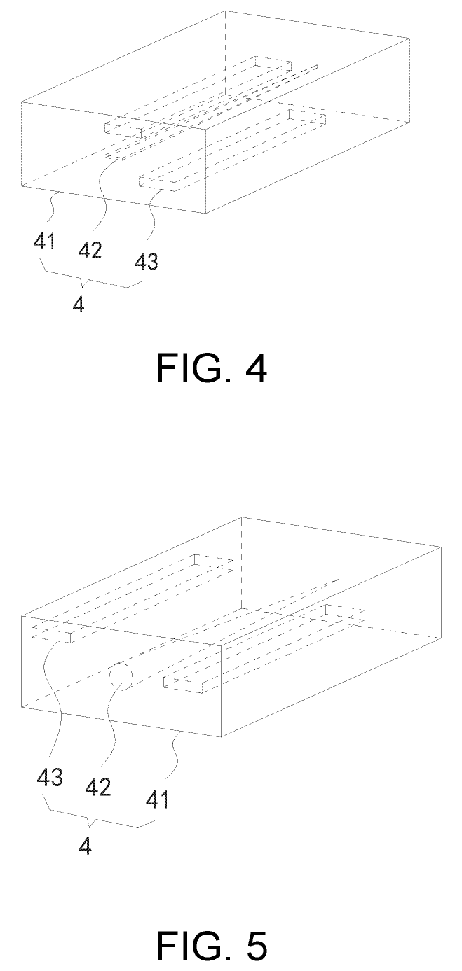

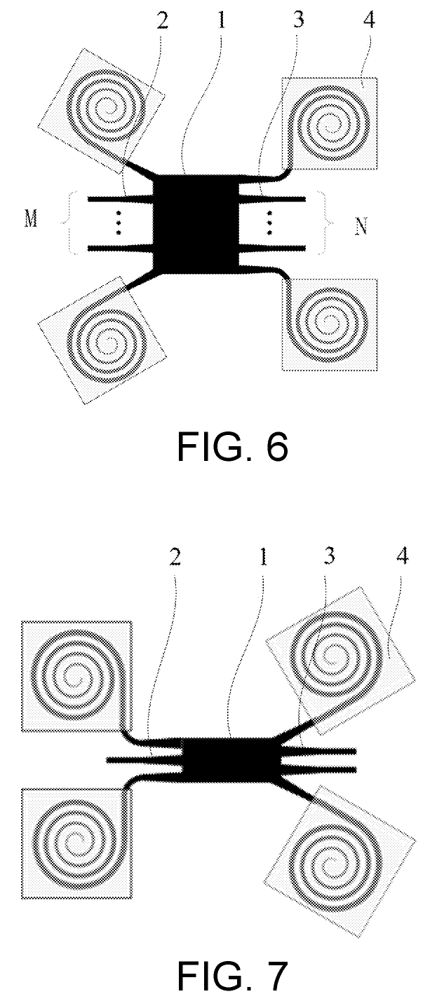

In a plurality of specific embodiments, shown as FIG. 4 and FIG. 5, a shape of the optical waveguide core 42 is tapered or wedge-shaped, that is, a radial dimension decreases gradually from the first end of the optical waveguide core 42 to the second end, and the optical waveguide core 42 is arranged in a straight line, or in a spiral shape or a folded loop shape in the 2D space or the 3D space. Specifically, in a process of the light propagating along a wedge-shaped optical waveguide core having a radial dimension decreasing gradually, a confinement ability of the waveguide to an optical field weakens gradually, resulting in a reduced distribution of the light in the optical waveguide core 42 but an increased distribution of the light in the waveguide cladding 41, that is, a size of an optical mode field increases gradually. When a profile of an optical mode is expanding larger, an evanescent tail at a periphery of the optical mode (an edge of the optical mode field formed by a light spot spreading outwards after becoming bigger) begins to touch the absorbing material layer 43 on an upside, due to the absorbing material layer 43 introducing absorption, thus an optical power propagating along the waveguide is attenuated. Since a tapered or wedge-shaped gradient is smooth enough to avoid an abrupt change, thus a backward-reflection can be reduced significantly. The optical waveguide core 42 is arranged in a straight line, or in a spiral shape or a folded loop in the 2D space or the 3D space. Since the optical waveguide core 42 is arranged in the straight line, or in the spiral shape or the folded loop in the 2D space or the 3D space, it helps to save a space in the photonic integrated circuit component, making an integration level of the circuit component higher. The absorbing material layer 43 is arranged on an upper layer of the optical waveguide core 42, or on a side of the optical waveguide core 42 (one side or both sides), or on a lower layer of the optical waveguide core 42, or on an oblique side of the dielectric optical waveguide (such as a lower right side shown in FIG. 4 or an upper left side shown in FIG. 5). A material of the absorbing material layer 43 is metal, silicon, or more. Preferably, a light-absorbing silicon layer is able to form a PN junction or a PIN junction through an ion-doping process; the PN junction or the PIN junction is configured to remove a plurality of free carriers converted after absorbing a light through applying a reverse bias voltage. It is not necessary for the light absorber 4 to be prepared by an ion-doping, or by introducing a plurality of other materials including germanium and more, making a structure thereof easy to manufacture and differentiating from two existing solutions (i.e., using a transition structure or using an absorption material like germanium (Ge)). It is noted that, taking FIG. 4 and FIG. 5 as an example, in the 3D space, besides two planes where the two ends (the first end and the second end) of the optical waveguide core 42 is located, the absorbing material layer 43 can be arranged at anyone position around the optical waveguide core 42.

Wherein, the multi-mode waveguide 1 of the MMI coupler shown in FIG. 2 and FIG. 3 comprises one input channel 2 and two output channels 3. It should be appreciated that, as shown in FIG. 6, a number of the input channel 2 and the output channel 3 of the multi-mode waveguide 1 in the MMI coupler can be expanded to M and N respectively, wherein M and N are positive integers. As shown in FIG. 6, the light absorbers 4 are arranged at all four corners of the MMI coupler, or as shown in FIG. 2, the light absorbers 4 are arranged at two corners (part of the corners) of the input channel 2 in a multi-mode coupler

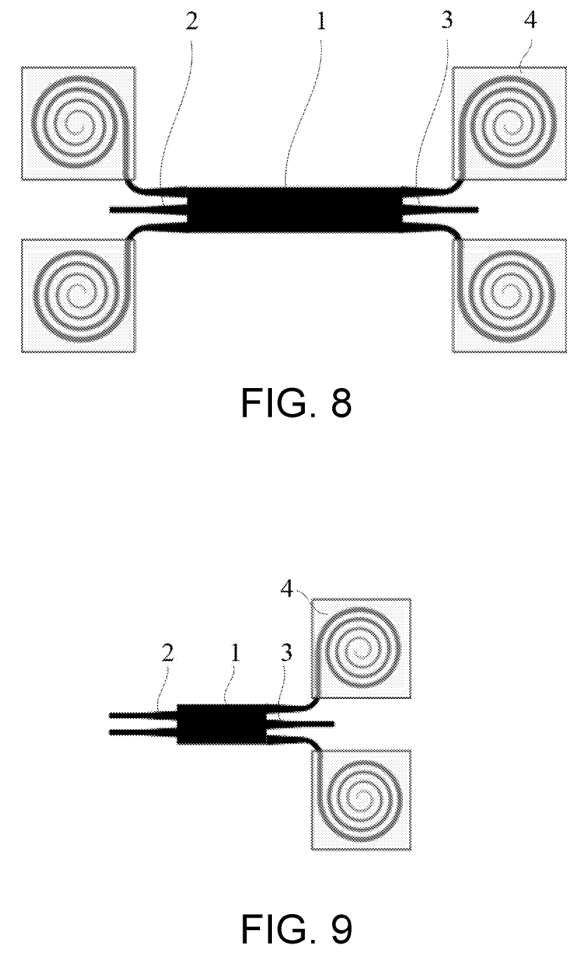

In an embodiment, FIG. 7 illustrates a 1×2 MMI coupler (with one input channel 2 and two output channels 3). FIG. 8 illustrates a 1×1 MMI coupler (with one input channel 2 and one output channel 3).

In a plurality of embodiments, as shown in FIG. 6, the orientation of the light absorber 4 is in any direction

In a plurality of specific embodiments, as shown in FIG. 6, the orientation of the light absorbers 4 at different right angles of the multi-mode waveguide 1 may be same or different.

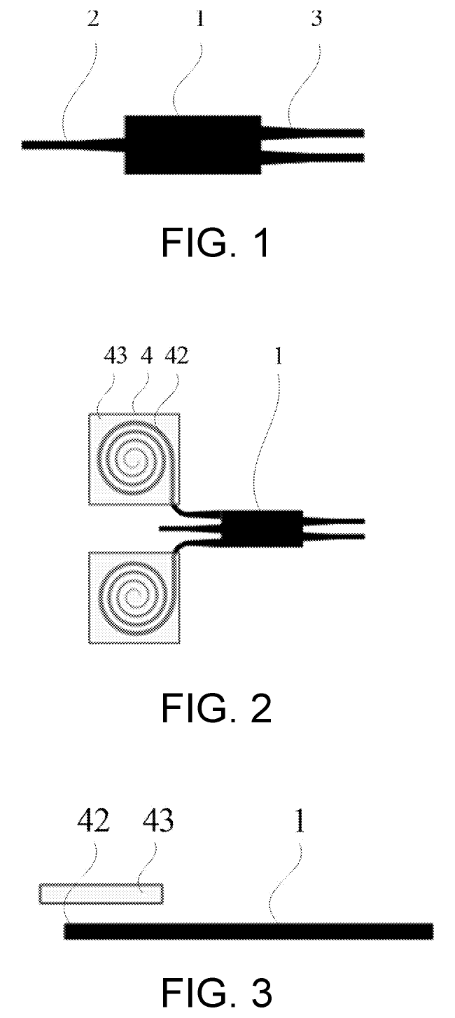

It should be noted that, the multi-mode waveguide 1 has a certain thickness in the 3D space, and a thickness of the optical waveguide core 42 in the light absorber 4 is as same as that of the multi-mode waveguide 1 (referencing to FIG. 3). In an embodiment, taking a top view shown in FIG. 1 and FIG. 2 as a top surface (and a surface opposite to the top surface is a bottom surface) of the multi-mode waveguide 1, a side view shown in FIG. 3 as a left side surface (and a surface opposite to the left side surface is a right side surface) of the multi-mode waveguide 1, a surface of the end where the input channel 2 of the multi-mode waveguide 1 is located as a front surface, and a surface of the end where the output channel 3 is located as a back surface (opposite to the front surface), thus in the 3D space, the front surface/ the back surface of the multi-mode waveguide 1 is divided into three regions adjacent to each other (a region locating in a middle where the input channel/ output channel is located, and two regions locating on both sides of the input channel) in a thickness direction, the right angle in the present application actually refers to the regions of the multi-mode waveguide 1 locating on both sides of the input channel or the regions on both sides of the output channel, and when arranging the light absorber 4, the optical waveguide core 42 is close to an edge between two surfaces of the front surface connecting to the left side surface (or the right side surface) of the multi-mode waveguide 1, or the optical waveguide core 42 is close to an edge between two surfaces of the back surface connecting to the left side surface (or the right side surface) of the multi-mode waveguide 1.

In a plurality of specific embodiments, as shown in FIG. 6, each of the two adjacent right angles on the end where the input channel 2 of the multi-mode waveguide 1 is located has a light absorber 4 arranged, and an orientation of each light absorber 4 is in a direction parallel to or at an angle with an optical propagation direction of the multi-mode waveguide 1; and each of the two adjacent right angles on the end where the output channel 3 of the multi-mode waveguide 1 is located has a light absorber 4 arranged, and orientations of both light absorbers 4 are in a direction parallel to the optical propagation direction of the multi-mode waveguide 1. As long as the orientation of the light absorber 4 does not intersect with the optical propagation direction of the multi-mode waveguide 1, an absorption to the reflected light will be achieved. Therefore, no matter the light absorber 4 is arranged at the end where the input channel 2 is located or at the end where the output channel 3 is located, it is only necessary to ensure that the optical waveguide core 42 of the light absorber 4 does not intersect with the multi-mode waveguide 1. It should be appreciated that, as shown in FIG. 6, although the light absorbers 4 at the two adjacent right angles on the end where the output channel 3 is located are in a same direction, an arrangement during an actual use is still differently. In an embodiment, a light absorber 4 on a top side is arranged parallel to the optical propagation direction of the multi-mode waveguide 1, while a light absorber 4 on a lower side is arranged downward obliquely.

In a plurality of specific embodiments, as shown in FIG. 8, each of the four right angles on the end of the multi-mode waveguide 1 has one light absorber 4 arranged, and an orientation of each light absorber 4 is parallel to the optical propagation direction of the multi-mode waveguide 1.

In a plurality of specific embodiments, as shown in FIG. 6, each of the four right angles on the end of the multi-mode waveguide 1 has one of the light absorber 4 arranged, and the first end of the optical waveguide core 42 in each of the light absorber 4 is connected with the right angle of the multi-mode waveguide 1 where the light absorber 4 is located.

In a plurality of embodiments, as shown in FIG. 9, the MMI coupler further comprises a polarization rotator 5, the first end of the optical waveguide core 42 in each of the light absorber 4 is connected with the right angle of the multi-mode waveguide 1 where the light absorber 4 is located through the polarization rotator 5. The polarization rotator 5 is configured to rotate a TE (transverse electric) polarized light being input for 90 degrees and converting into a TM (transverse magnetic) polarized light, and then output the TM polarized light. The light absorber 4 is configured to absorb the TM polarized light. Since the light absorber 4 has a higher absorption efficiency to the TM polarized light, such a structure is able to absorb a light wave more efficiently.

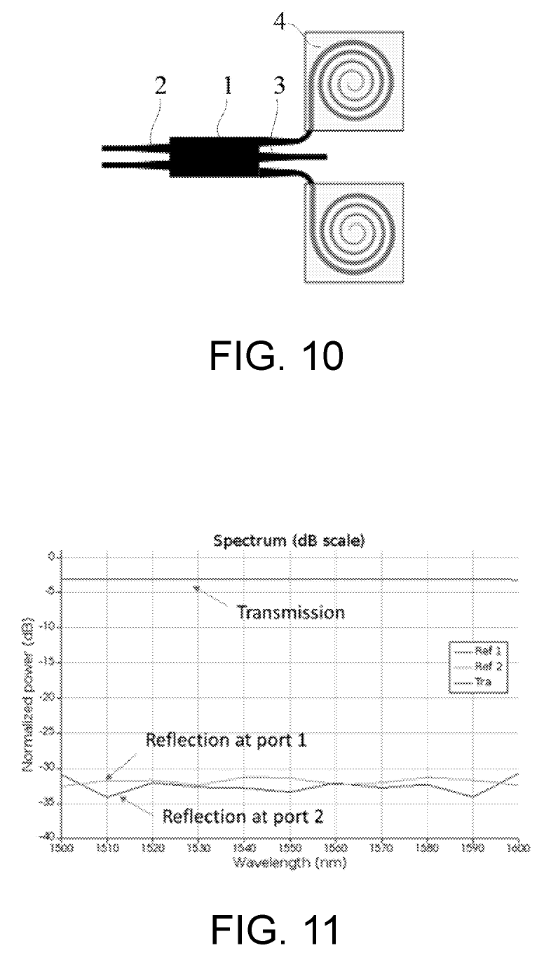

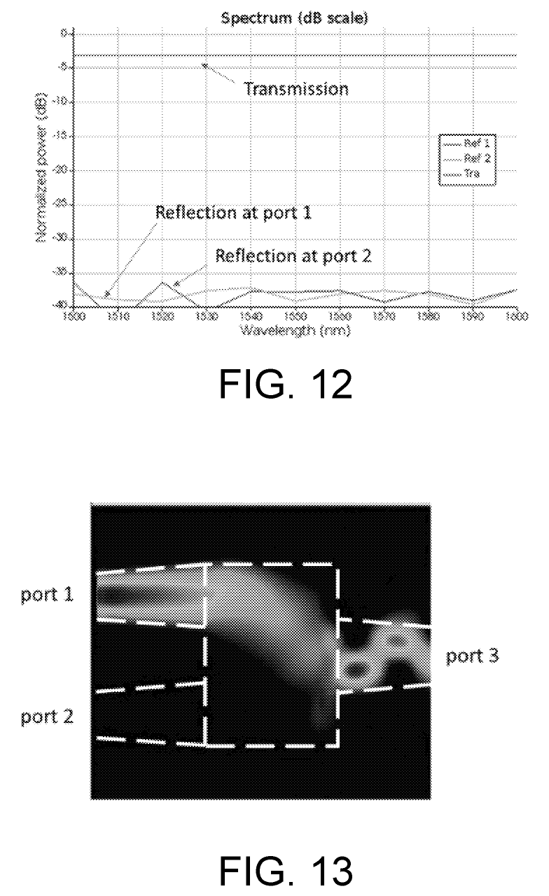

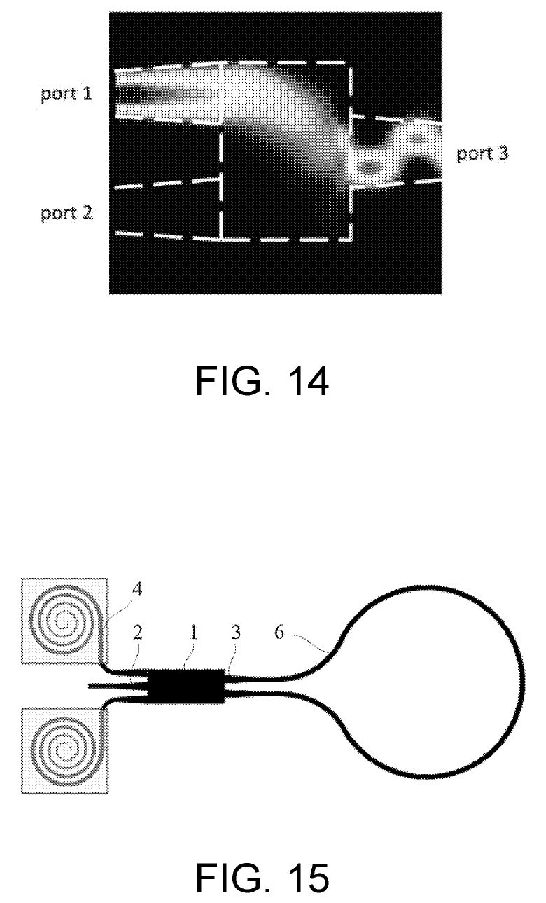

In an embodiment, shown as FIG. 10, a 2×1 MMI coupler has the optical waveguide core 42 made of a silicon nitride material and an absorbing material is aluminum. Wherein, FIGS. 11-14 illustrate a role of the light absorber 4 in the 2×1 MMI coupler. Specifically, FIG. 11 illustrates a transmission spectrum and a reflection spectrum of a conventional 2×1 MMI coupler without the light absorber 4, wherein an intensity of the reflected light at both ports is -30dB ~ -35dB. FIG. 12 illustrates a transmission spectrum and a reflection spectrum of a conventional 2×1 MMI coupler having the light absorber 4 arranged, wherein an intensity of the reflected light at both ports is lowered to -35 dB ~ -40 dB. FIG. 13 and FIG. 14 illustrate two light intensity distribution diagrams on the two MMI couplers stated above. Thus, by arranging the light absorbers 4 at the corners of the multi-mode waveguide 1 of the MMI coupler, the present application is able to reduce the return loss effectively and eliminate the reflected light, leading the reflected light to be absorbed by the absorbing material layer 43, thereby reducing the reflection of the MMI coupler.

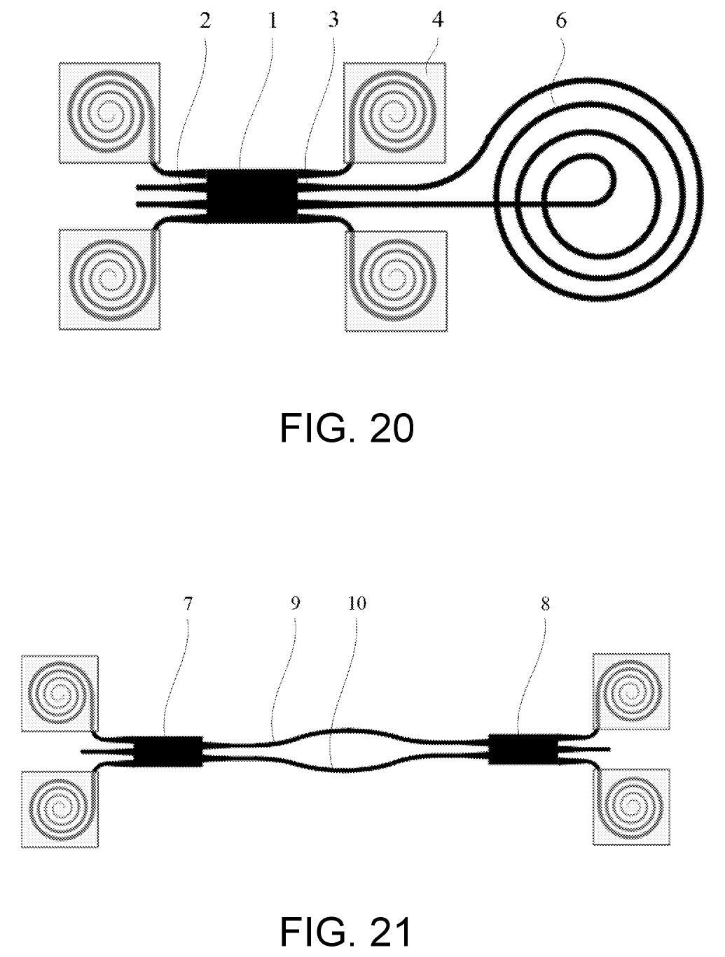

An interferometer is shown as FIG. 15, FIG. 20 and FIG. 21, the interferometer comprises a MMI coupler, a light absorber 4 arranged at each corner of the multi-mode waveguide 1 in the MMI coupler, and a waveguide routing or a coil 6 connected with the multi-mode waveguide 1 in the MMI coupler. Wherein, the interferometer is a Mach-Zehnder interferometer (MZI)-type modulator, a Sagnac interferometer, an interference type optical gyroscope, an optical switch or a semiconductor ring laser.

In an embodiment, shown as FIG. 15, when the interferometer is a Sagnac interferometer, each of two right angles adjacent to each other on an end where the input channel 2 of the multi-mode waveguide 1 in the MMI coupler locates has a light absorber 4 arranged, and each light absorber 4 is arranged in a direction parallel to an optical propagation direction of the multi-mode waveguide 1; one output channel 3 of the multi-mode waveguide 1 is connected to one end of the coil 6, and another output channel 3 is connected to another end of the coil 6.

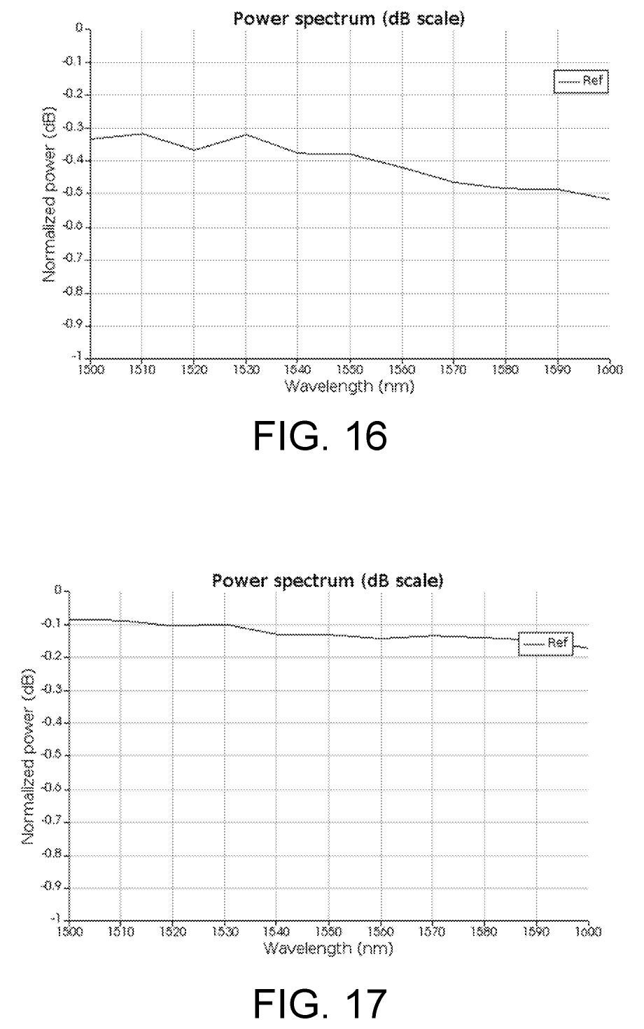

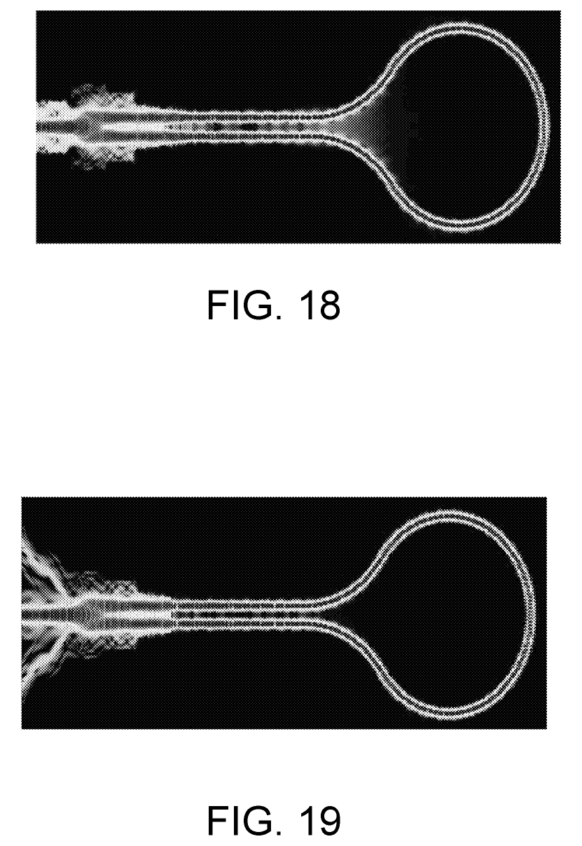

In the Sagnac interferometer, the optical waveguide core 42 of the light absorber 4 is made of silicon nitride and an absorbing material is aluminum. The Sagnac interferometer is configured to reflect the light completely and minimizing a loss involved in a reflection process. FIGS. 16-19 show a role of the light absorber 4 in such a Sagnac interferometer. FIG. 16 illustrates a reflection spectrum on a Sagnac interferometer of a dielectric waveguide-based MMI coupler without a light absorber 4, a loss thereof is approximately 0.3 dB ~ 0.5 dB. FIG. 17 illustrates a reflection spectrum on a Sagnac interferometer of a dielectric waveguide-based MMI coupler with a light absorber 4, a loss thereof is approximately 0.1 dB ~ 0.15 dB. Each of FIG. 18 and FIG. 19 shows a light intensity distribution diagram on each of two MMI couplers stated above respectively. Therefore, by applying a Sagnac interferometer of a MMI coupler with a light absorber 4 described in the present application, it is possible to reduce the return loss effectively and eliminate the reflected light, leading the reflected light to be absorbed by the absorbing material layer 43, thereby reducing the reflection of the interferometer.

In an embodiment, shown as FIG. 20, when the interferometer is an interference type optical gyroscope, each of four right angles at the end of the multi-mode waveguide 1 in the MMI coupler has a light absorber 4 arranged, and an orientation of each light absorber 4 is parallel to the optical propagation direction of the multi-mode waveguide 1; wherein, the coil 6 is a spiral coil; one output channel 3 of the multi-mode waveguide 1 is connected to one end of the spiral coil, another output channel 3 is connected to another end of the spiral coil; wherein, the spiral coil can be wound in a plurality of different ways and can be located in a same plane or in different planes in a 3D space; when the spiral coil is located in the same plane, there is a waveguide crossing comprised. In addition, the spiral coil may be integrated into a same chip or different chips, or may be an optical fiber spiral coil coupled externally.

In an embodiment, shown as FIG. 21, when the interferometer is a Mach-Zehnder interferometer, the Mach-Zehnder interferometer comprises a first MMI coupler 7, a second MMI coupler 8, a first waveguide routing 9 and a second waveguide routing 10; a light absorber 4 is arranged on each of two adjacent right angles on an end where the input channel 2 of the first multi-mode waveguide 1 in the first MMI coupler 7 locates, and an orientation of each light absorber 4 is parallel to an optical propagation direction of the first multi-mode waveguide 1; a light absorber 4 is arranged on each of two adjacent right angles on an end where the output channel 3 of the second multi-mode waveguide 1 in the second MMI coupler 8 locates, and an orientation of each light absorber 4 is parallel to an optical propagation direction of the second multi-mode waveguide 1; an output channel 3 of the first multi-mode waveguide 1 is connected to an input channel 2 of the second multi-mode waveguide 1 through the first waveguide routing 9; another output channel 3 of the first multi-mode waveguide 1 is connected to another input channel 2 of the second multi-mode waveguide 1 through the second waveguide routing 10; wherein, a length of the first waveguide routing 9 and the second waveguide routing 10 may be same or different.

A platform for integrated materials where the structures stated above are located comprises at least one of silicon nitride, silicon dioxide, aluminum oxide, indium phosphide, lithium niobate, barium titanate and polymers. A type of the waveguide comprises a channel waveguide, a ridge waveguide, a slotted waveguide, a diffused waveguide, and a photonic crystal waveguide. A range for a working wavelength of the structure comprises a visible band, an O-band, an E-band, an S-band, a C-band, an L-band, a U-band, and a mid-infrared band. An application field of the structure comprises optical communication, optical interworking, an optical switch, a laser radar, a semiconductor ring laser, an interference type optical gyroscope, beam control, optical sensing, free-space optical communication, optical storage, optical computing, and more.

While embodiments of the present application are described in detail above, it is apparent to ordinary technical personnel in the field that, various modifications and variations can be made to the embodiments described above. However, it should be understood that such modifications and variations fall within the scope and intention of the present application as stated in the claims. Further, there may be other embodiments of the present application described herein, which can be implemented or realized in various ways.

What is claimed is:

1. A dielectric waveguide-based MMI coupler, comprising:
a multi-mode waveguide, one end of the multi-mode waveguide is connected to M input channels and another end is connected to N output channels, wherein both M and N are positive integers; and
a light absorber, comprising a waveguide cladding, an optical waveguide core and an absorbing material layer; the optical waveguide core and the absorbing material layer are surrounded by the waveguide cladding; wherein the optical waveguide core and the absorbing material layer are not directly connected with each other, the optical waveguide core comprises a first end and a second end, while a radial dimension of the optical waveguide core decreases gradually from the first end to the second end;
wherein at least one end of the multi-mode waveguide has the light absorber arranged, and the first end of the optical waveguide core of the light absorber is connected to the end of the multi-mode waveguide where the light absorber is located; and
a material of both the multi-mode waveguide and the optical waveguide core of the light absorber is a dielectric.

2. The MMI coupler according to claim 1, wherein orientations of the light absorber are adjustable.

3. The MMI coupler according to claim 2, wherein the orientations of the light absorbers at different right angles in the multi-mode waveguide are same or different.

4. The MMI coupler according to claim 3, wherein at least one of two adjacent right angles on the end where the input channel or the output channel of the multi-mode waveguide is located, has a light absorber arranged, and an orientation of each light absorber is in a direction parallel to or at an angle with an optical propagation direction of the multi-mode waveguide.

5. The MMI coupler according to claim 3, wherein each of four right angles on the end of the multi-mode waveguide has a light absorber arranged, and the orientation of each light absorber is parallel to or at an angle with the optical propagation direction of the multi-mode waveguide.

6. The MMI coupler according to claim 1, wherein each of four right angles on the end of the multi-mode waveguide has one of the light absorbers arranged, and the first end of the optical waveguide core in each of the light absorbers is connected with the right angle of the multi-mode waveguide where the light absorber is located.

7. The MMI coupler according to claim 1, further comprising:
a polarization rotator, through the polarization rotator, the first end of the optical waveguide core in the light absorber is connected with a right angle of the multi-mode waveguide where the light absorber is located.

8. The MMI coupler according to claim 1, wherein a shape of the optical waveguide core is tapered or wedge-shaped, and the optical waveguide core is arranged in a straight line, or in a spiral shape or a folded loop in a 2D space or a 3D space.

9. The MMI coupler according to claim 1, wherein the absorbing material layer is located on an upper layer of the optical waveguide core, or on a side of the optical waveguide core, or on an oblique side of the optical waveguide core, or on a lower layer of the optical waveguide core.

10. An interferometer, comprising at least one of the MMI coupler according to claim 1 and a waveguide routing or a coil connected with the M input channels or the N output channels of the MMI coupler.

11. The interferometer according to claim 10, wherein the interferometer is a Mach-Zehnder interferometer-type modulator, a Sagnac interferometer, an interference type optical gyroscope, an optical switch, or a semiconductor ring laser.

12. The interferometer according to claim 11, wherein the interferometer is the Sagnac interferometer, at least one of two adjacent right angles on the end where the M input channels of the multi-mode waveguide in the MMI coupler are located has a light absorber arranged, and an orientation of each light absorber is parallel to or at an angle with the optical propagation direction of the multi-mode waveguide;
one output channel of the multi-mode waveguide is connected to one end of the coil, another output channel is connected to another end of the coil.

13. The interferometer according to claim 11, wherein the interferometer is the interference type optical gyroscope, at least one of four right angles on the end of the multi-mode waveguide in the MMI coupler has a light absorber arranged, and an orientation of each light absorber is parallel to or at an angle with the optical propagation direction of the multi-mode waveguide; wherein the coil is a spiral coil;
One output channel of the multi-mode waveguide is connected to one end of the spiral coil, another output channel is connected to another end of the spiral coil; wherein a winding of the spiral coil is located in a same plane or in different planes in a 3D space; when located in the same plane, the spiral coil comprises a waveguide crossing.

14. The interferometer according to claim 13, wherein the spiral coil is integrated into a same chip or different chips, or is an optical fiber spiral coil coupled externally.

15. The interferometer according to claim 11, wherein the interferometer is a Mach-Zehnder interferometer, comprising a first MMI coupler, a second MMI coupler, a first waveguide routing and a second waveguide routing;
wherein at least one of two adjacent right angles on the end where the input channel of a first multi-mode waveguide of the first MMI coupler is located has a light absorber arranged, and an orientation of each light absorber is parallel to or at an angle with the optical propagation direction of the first multi-mode waveguide;
at least one of two adjacent right angles on the end where the output channel of a second multi-mode waveguide in the second MMI coupler is located has a light absorber arranged, and each light absorber is arranged in a direction parallel to or at an angle with the optical propagation direction of the second multi-mode waveguide;
an output channel of the first multi-mode waveguide is connected to an input channel of the second multi-mode waveguide through the first waveguide routing;
another output channel of the first multi-mode waveguide is connected to another input channel of the second multi-mode waveguide through the second waveguide routing; wherein a length of the first waveguide routing and a length of the second waveguide routing is same or different.
